(19) United States
(12) Patent Application Publication
(10) Pub. No.: US 2006/0022003 A1
(43) Pub. Date: Feb. 2, 2006

(54) Detachable mounting device for mobile auto entertainment unit

(76) Inventor: Edward Zheng, La Verne, CA (US)

Correspondence Address: RAYMOND Y. CHAN, 108 N. YNEZ AVE., SUITE 128, MONTEREY PARK, CA, 91754, US

(21) Appl. No.: 10/903,926

(22) Filed: Jul. 31, 2004

(51) Int. Cl. B60R 7/00

(52) U.S. Cl. 224/275; 224/929

(57) ABSTRACT

A detachable mounting device, adapted for mounting a mobile auto entertainment unit to a vehicle seat, includes a docking frame for detachably mounting the mobile auto entertainment unit, a fastening unit having a fastening loop for detachably fastening to the vehicle seat to support the docking frame at a rear side of the vehicle seat, and a retention unit pivotally connected with the docking frame, wherein when the retention unit is outwardly and pivotally folded from the docking frame for biasing against the rear side of the vehicle seat, the retention unit is adapted to not only minimize a clearance of the fastening loop with respect to the vehicle seat to retain the docking frame in position but also selectively adjust a tilted angle of the docking frame with respect to the rear side of the vehicle seat for adjusting an eye-to-screen distance of the mobile auto entertainment unit.

### BACKGROUND OF THE PRESENT INVENTION

1. Field of Invention

The present invention relates to an accessory for a mobile auto entertainment device, and more particularly to a detachable mounting device for detachably mounting a mobile auto entertainment unit, such as a DVD player to a vehicle, so that no installation is required to incorporate the mobile auto entertainment unit with the vehicle.

2. Description of Related Arts

Nowadays, a lot of cars have been equipped with some audio/mobile auto entertainment units to attract more possible buyers. So, it is witnessed that the in-car entertainment market has been grown rapidly since it became possible to watch movies and listen to music during a bored long trip journey, and this is largely because the DVD format, i.e. Digital Versatile Discs, provides quality pictures and all the bonus material the passengers could want to fill time on the road, and more importantly, keep the children quiet.

DVD players built into the vehicle's integrated circuit system are impressive, but they are exclusively applicable in some luxury cars. This is due to the fact that the built-in type DVD players are often expensive and require rear screens for passengers to work well. Such built-in type DVD players required a complicated wiring installation system in order to connect the head unit of the DVD player to the rear screen wherein the wiring installation system comprises a plurality of video and audio signal cables extended throughout the vehicle. Therefore, technicians will drill holes at the vehicle panels to allow the signal cables passing through. In other words, such built-in type DVD players not only damage the structure of the vehicle but also require relatively high installation cost paid by the vehicle owner. Furthermore, the DVD players installed in a car as luxury peripheral devices are susceptible to be stolen. When the car is parked, a car lifter could easily break into the car and steal the expensive DVD players.

So, the portable DVD players are rising as fantastic devices replacing traditional built-in DVD players used for a car. Needless to say, the portable DVD players have a bunch of advantages compared with built-in type DVD players. They could be mounted in different places within a car, they could be detached from the car when the car is parking, they could help pass the time whether passengers are in or out the car, they could be used when passengers are resting in a motel room, and camping in tent. Anyway, they could be used anywhere passengers would like to relax and watch a movie during a long trip.

Nevertheless, mounting a portable DVD player to a car is by no means an easy job. For the safety issues, the portable DVD players are commonly provided in a car to serve the passengers seating in the rear row instead of the drivers or the front seat passengers. Even though the portable DVD players could be conveniently positioned on the front panel of a car, but this is not recommended by safety councils. As a result, it is widely seen that the DVD players always being fastened on the back surface of a front seat or being hanged on the roof of a car.

It is well known that the car seat designing must be subject to some policies or rules. Otherwise, a poor seat design will ruthlessly cause some back pains of people. This is due to the fact that how people sit within a car affects the health of the spine.

To ensure that passengers seating within a car feel more comfortable, the car seats are always designed to have a slope or inclined profile, so that passengers could rest on that seat removing weight from the feet and maintain a stable posture and muscles not directly involved with the work can relax.

However, this sloped designing cause some troubles for fastening a DVD player to the back surface of a car seat to satisfying the visual ergonomic research.

To ensure passengers being enjoyable and relax during a car tripping DVD entertainment, the placement of monitor of DVD players must be highly concerned. Certainly, the closeness and instability of the monitor will definitely cause eyestrain of people. That is to say, before installing a DVD player within a car, a lot of factors such as the eye-to-screen distance, the vertical location of the DVD player, the tilt angle of DVD player, must be thoroughly considered to maintain the DVD player in a stable manner for appeasing viewer' eyes.

Unfortunately, in case of the DVD players are tightly fastened on a back surface of the car seat, it is impossible for uprightly disposing the monitor of the DVD player; the inwardly tilted angle of the DVD monitor will cause visual fatigue of viewer. Furthermore, if the DVD player is suspending with one end fastened on the seat to keep the monitor upright with respect to the horizontal surface, the stability is another insurmountable problem since the car is constantly moving and bumping. As a result, the monitor would be sway like a pendulum during the trip. The problem becomes aggravated if the surface at the road is uneven or badly conditioned.

Not surprisingly, it is so desirable to develop an improved mounting devices for not only securely holding the DVD players in position, but also satisfying the ergonomic concerns so as to ensure viewer's visual relax during the enjoyment of such DVD players in a car.

### SUMMARY OF THE PRESENT INVENTION

A main object of the present invention is to provide a detachable mounting device for detachably mounting a mobile auto entertainment unit to a vehicle seat, wherein the detachable mounting device is capable of not only securely holding the mobile auto entertainment unit in position but also allowing the mobile auto entertainment unit to be selectively adjusted its angular position with respect to the vehicle seat, so as to adjust the optimized eye-to-screen distance of the mobile auto entertainment unit.

Another object of the present invention is to provide a detachable mounting device for detachably mounting a mobile auto entertainment unit to a vehicle seat, wherein the position of the detachable mounting device is easily adjusted to accommodate different inclined angle of the vehicle seat.

Another object of the present invention is to provide a detachable mounting device for detachably mounting a mobile auto entertainment unit to a vehicle seat, wherein the detachable mounting device can be incorporate with any kind of vehicle seat to detachably mount the mobile auto entertainment unit thereon such that the vehicle seat does not require to alter its original structure in order to incorporate the mobile auto entertainment unit.

Another object of the present invention is to provide a detachable mounting device for detachably mounting a mobile auto entertainment unit to a vehicle seat, wherein the mobile auto entertainment unit can be simply detached from the detachable mount device without detaching the detachable mounting device from the vehicle seat.

Another object of the present invention is to provide a detachable mounting device for detachably mounting a mobile auto entertainment unit to a vehicle seat, wherein no complicated structure or parts are required for fulfilling the objects.

Accordingly, to achieve the above mentioned objects, the present invention provides a detachable mounting device for detachably mounting a mobile auto entertainment unit to a vehicle seat, comprising:
a docking frame for detachably mounting the mobile auto entertainment unit;
a fastening unit having a fastening loop for detachably fastening to the vehicle seat to support the docking frame at a rear side of the vehicle seat; and
a retention unit pivotally connected with the docking frame, wherein when the retention unit is outwardly and pivotally folded from the docking frame for biasing against the rear side of the vehicle seat, the retention unit is adapted to not only minimize a clearance of the fastening loop with respect to the vehicle seat to retain the docking frame in position but also selectively adjust a tilted angle of the docking frame with respect to the rear side of the vehicle seat for adjusting an eye-to-screen distance of the mobile auto entertainment unit.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a detachable mounting device for detachably mounting a mobile auto entertainment unit to a vehicle seat according to the preferred embodiment of the present invention.

FIG. 2 is an exploded perspective view of the detachable mounting device for detachably mounting the mobile auto entertainment unit 1ccording to the above preferred embodiment of the present invention.

FIG. 3 is side view of the detachable mounting device for detachably mounting the mobile auto entertainment unit 1ccording to the above preferred embodiment of the present invention.

FIG. 4A is a sectional view of an angle adjusting arrangement of the detachable mounting device according to the above preferred embodiment of the present invention, illustrating the mobile auto entertainment unit being free to rotate to adjust an angle with respect to the docking frame.

FIG. 4B is a sectional view of an angle adjusting arrangement of the detachable mounting device according to the above preferred embodiment of the present invention, illustrating the mobile auto entertainment unit being locked at the angle with respect to the docking frame.

FIG. 5 illustrates an alternative mode of the angle adjusting arrangement of the detachable mounting device according to the above preferred embodiment of the present invention.

FIG. 6 illustrates an alternative mode of the fastening unit of the detachable mounting device according to the above preferred embodiment of the present invention.

### DETAILED DESCRIPTION OF THE PREFERRED EMBODIMENT

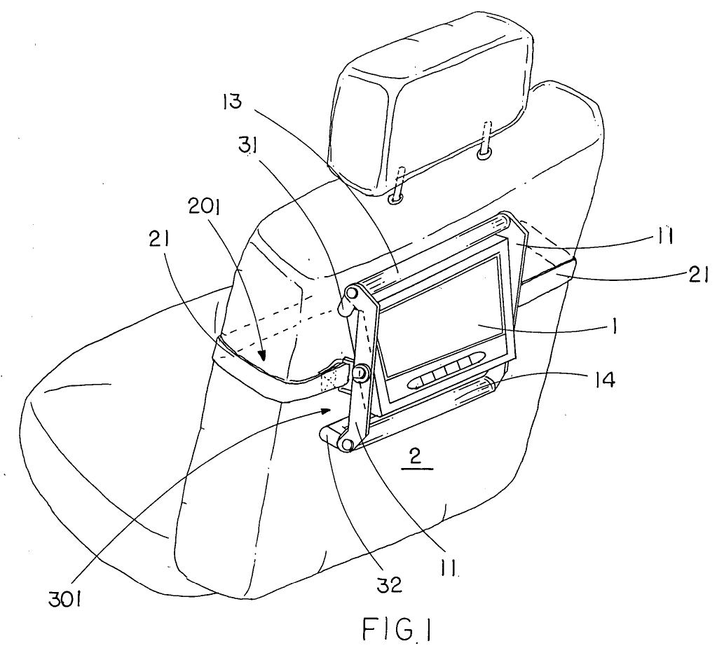

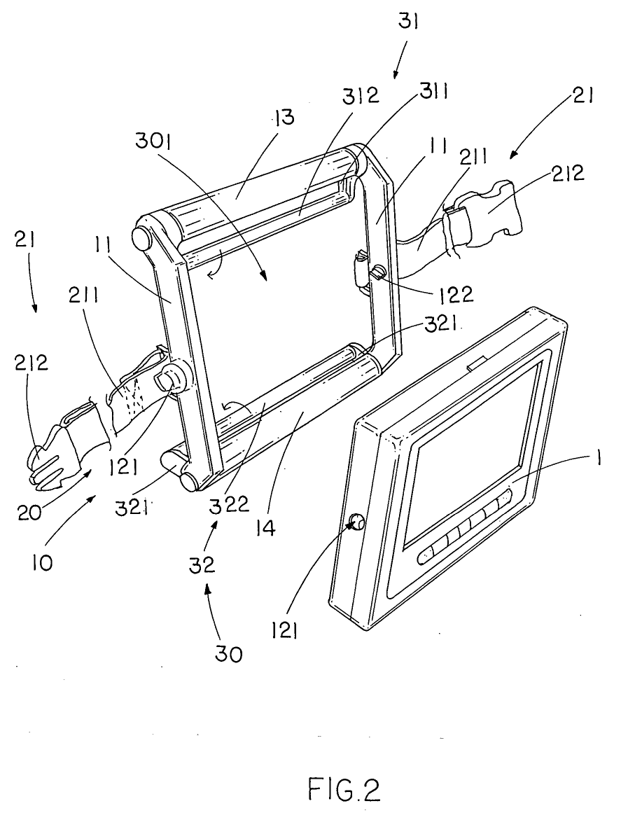

Referring to the FIGS. 1 and 2 of the drawings, a detachable mounting device according to the preferred embodiment of the present invention is illustrated, wherein the detachable mounting device for detachably mounting a mobile auto entertainment unit 1 having a screen, such as a DVD player or a VCD player, to a vehicle seat 2.

The detachable mounting device comprises a docking frame 10 for detachably mounting the mobile auto entertainment unit 1 and a fastening unit 20 having a fastening loop 201 for detachably fastening to the vehicle seat 2 to support the docking frame 10 at a rear side of the vehicle seat 2.

The detachable mounting device further comprises a retention unit 30 pivotally connected with the docking frame 10, wherein when the retention unit 30 is outwardly and pivotally folded from the docking frame 10 for biasing against the rear side of the vehicle seat 2, the retention unit 30 is adapted to not only minimize a clearance of the fastening loop 201 with respect to the vehicle seat 2 to retain the docking frame 10 in position but also selectively adjust a tilted angle A of the docking frame 10 with respect to the rear side of the vehicle seat 2 for adjusting an eye-to-screen distance of the mobile auto entertainment unit 1.

The docking frame 10 comprises two side arms 11 laterally disposed in a parallel manner for receiving the mobile auto entertainment unit therebetween and an angle adjusting arrangement 12 provided at the two side arms 11 for detachably mounting the mobile auto entertainment unit 1 in position between the two side arms 11. Preferably, the mobile auto entertainment unit 1 is pivotally mounted to the side arms 11 via angle adjusting arrangement 12 so that the mobile auto entertainment unit 1 is capable of being moved in a pivotal manner with respect to the two side arms 11 of docking frame 10. Therefore, the passengers could enjoy the convenience of easy adjustability of a tilted angle of the screen of the mobile auto entertainment unit 1.

As shown in FIG. 2, the docking frame 10 further comprises an upper arm 13 transversely extended between two upper ends of the side arms 11 and a lower arm 14 transversely extended between two lower ends of the side arms 11 to form a boundary frame to receive the mobile auto entertainment unit 1 within the two side arms 11, the upper arm 13 and the lower arm 14.

According to the preferred embodiment, the fastening unit 20 comprises two length-adjustable elongate elements 21 extended from two sides of the docking frame 10 to form the fastening loop 201 when the elongated elements 21 are fastened with each other. Accordingly, the two elongated elements 21 are sidewardly extended from two side arms 11 respectively to fasten together to form the loop 201 for encirclingly holding the docking frame 10 to the vehicle seat 2.

The two elongated elements 21 comprises two length-adjustable elongated straps 211 sidewardly extended from the side arms 11 and two fasteners 212 provided at two free ends of the elongated straps 211 respectively wherein the two fasteners 212 are detachably attached together to form the fastening loop 201 by the elongated straps 211.

It is noted that the fasteners 212 includes but not limited to buckle/belt fastening means, loop/hook fastening means, tongue/groove lock fastening means, straps fastening means and so on. In other words, the fastening unit 20 is used to securely hold the docking frame 10 at the rear side of the vehicle seat 2.

In the meanwhile, each of the elongate elements 21 is embodied adjustable its length to adjust the size of the fastening loop 201. This is due to the fact the vehicle seats 2 are shaped and sized of a variety of differences. For full size vehicle, the vehicle seat may embody as a “captain seat” having a bigger size. For a compact size vehicle, the vehicle seat may have smaller size. Therefore, by adjusting the size of the fastening loop 201 to tightly encircle the vehicle seat 2, the docking frame 10 can be securely held at the rear side of the vehicle seat 20. In addition, the docking frame 10 also can be positioned either at the upper portion of the vehicle seat 2 or lower portion thereof depending on the size of the fastening loop 201.

However, even the fastening unit 20 could hold the docking frame 10 to the vehicle seat 2 with a tight manner, the clearance of the fastening loop 201 is formed between the docking frame 10 and the rear side of the vehicle seat 2 such that the docking frame 10 may unavoidably slide at the rear side of the vehicle seat 2 especially when the vehicle is moving. Since the rear side of the vehicle seat 2 is not constructed to have a flat surface, the docking frame 10 is intended to move slightly. In addition, the vehicle seat 2 is usually adjusted at an inclined angle such that the driver/passenger can inclinedly lie down his or her back on the vehicle seat 2. However, when the mobile auto entertainment unit 1 is mounted to the docking frame 10 at an inclination angle with respect to the vehicle seat 2, the passenger sitting at the back seat is unable to see the screen of the mobile auto entertainment unit.

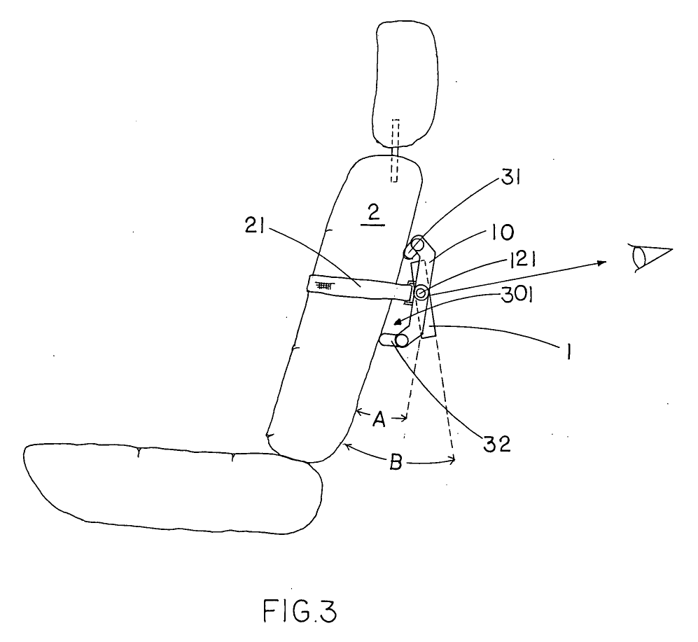

As shown in FIGS. 2 and 3, the retention unit 30 comprises an upper retention member 31 pivotally connecting to an upper portion of the docking frame 10 and a lower retention member 32 pivotally connecting to a lower portion of the docking frame 10 wherein each of the upper and lower retention members 31, 32, having a U-shaped structure, comprises two pivot arms 311, 321 pivotally extended from the docking frame 10 and a retention arm 312, 322 extended between the two pivot arms 311, 321 in such a manner that when the pivot arms 311, 321 are pivotally folded from the docking frame 10, the retention arms 321, 322 are folded for substantially biasing against the rear side of the vehicle seat 2 to push the docking frame 10 spacedly apart therefrom so as to minimize the clearance of the fastening loop 201 with respect to the vehicle seat 2.

Accordingly, the two pivot arms 311 of the upper retention member 31 are pivotally connected to two upper ends of the side arms 11 of the docking frame 10 and the two pivot arms 312 of the upper retention member 32 are pivotally connected to two lower ends of the side arms 11 of the docking frame 10. The upper retention member 31 is adapted to outwardly and upwardly fold from the docking frame 10 to bias against the rear side of the vehicle seat 2 while the lower retention member 32 is adapted to outwardly and downwardly fold from the docking frame 10 to bias against the rear side of the vehicle seat 2. It is worth to mention that a folding angle of each of the upper and lower retention members 31, 32 is limited to prevent the upper and lower retention members 31, 32 to pivotally flip over from the docking frame 10.

As it is mentioned above, in order to adjust the tilted angle A of the docking frame 10 with respect to the rear side of the inclined vehicle seat 2, the lower retention member 32 is adapted to fully fold to bias against the rear side of the vehicle seat 2 while the upper retention member 31 is adapted to slightly fold to bias against the rear side of the vehicle seat 2 such that the docking frame 10 can be supported at the rear side of the vehicle seat 2 in a vertical position, as shown in FIG. 3.

Therefore, no matter how tight the fastening loop 201 of fastening element 21 is encircled with the vehicle seat 2, the clearance of the fastening loop 201 will cause an unwanted movement of the docking frame 10 on the rear side of the vehicle seat 2. Therefore, the retention unit 30 can maintain the docking frame 10 in a stable manner by bracing up the upper and lower retention members 31, 32 to bias against the rear side of the vehicle seat 2, such that the retention unit 30 facilitates the fastening function of fastening unit 20 to keep the docking frame 10 in a stable manner from time to time.

In other words, the upper retention member 31 and lower retention member 32 are functioned as two footings biasing against the rear side of the vehicle seat 2. After the docking frame 10 is securely held on the vehicle seat 2, the upper retention member 31 and lower retention member 32 could be braced up to assist the fastening unit 20 for making the attachment even tighter. Additionally, the braced docking frame 10 enables the adjustability of a tilted angle of the mobile auto entertainment unit 1 being feasible. So the passenger could enjoy the show of the mobile auto entertainment unit with an ergonomic visual angle and stability.

Alternatively, the retention arms 312, 322 can be omitted such that the four pivot arms 311, 312 (two pivot arms 311 of the upper retention member 31 and two pivot arms 312 of the lower retention member 32) are capable of pivotally folding to bias against the rear side of the vehicle seat 2 to further enhance the angle adjustment of the docking frame 10 with respect to the rear side of the vehicle seat 2. Therefore, by folding the retention unit 30 with different angle, the docking frame 10 can be used over a variety of sloped rear side of the vehicle seat 2.

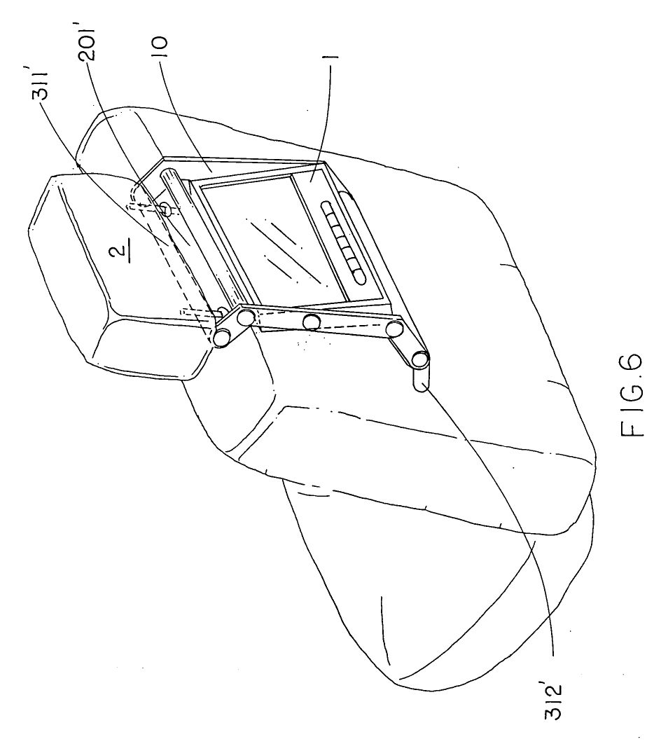

It is worth to mention that the upper retention member 311′ can be alternatively modified as the fastening unit 20′ having the fastening loop 201′ to encirclingly hang around the extension arms of the vehicle seat 2, as shown in FIG. 6, wherein the lower retention member 312′ is pivotally and outwardly folded to bias against the rear side of the vehicle seat 2 to adjust the titled angle A of the docking frame 10 to support the mobile auto entertainment unit 1.

According to the preferred embodiment, when the retention unit 30 is folded to bias against the rear side of the vehicle seat 2, an adjustable cavity 301 is formed within the docking frame 10 and the rear side of the vehicle seat 2 for allowing the mobile auto entertainment unit 1 to pivotally move within the adjustable cavity 301 via the angle adjusting arrangement 12. In other words, the adjustable cavity 301 is formed within the two side arms 11, the upper arm 13 and the lower arm 14 with respect to the rear side of the vehicle seat 2 such that when the upper and lower retention members 31, 32 are folded outwardly to bias against the rear side of the vehicle seat 2, the adjustable cavity 301 is substantially increased by the height of each of the upper and lower retention members 31, 32.

Accordingly, the upper and lower retention members 31, 32 are folded outwardly towards the rear side of the vehicle seat 2 to increase the size of the adjustable cavity 301 so as to maximize the pivot movement of the mobile auto entertainment unit 1 between the two side arms 11 of the docking frame 10.

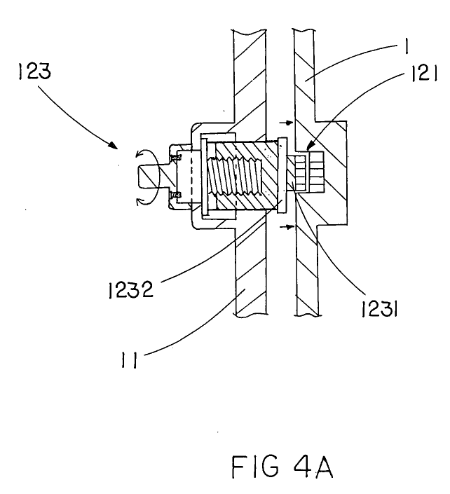

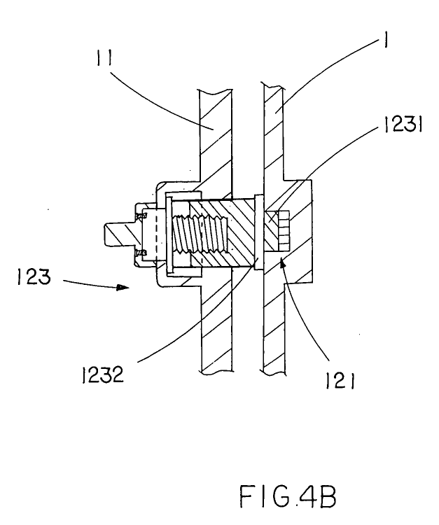

As shown in FIGS. 2 and 4B, the angle adjusting arrangement 12 has two sliding slots 121 provided at two sides of the mobile auto entertainment unit 1 and comprises a pivot joint 122 formed on one of the side arms 11 to rotatably engage with the corresponding sliding slot 121 and an adjustable locker 123 formed on another side arm 11 to engage with the another sliding slot 121 to lock up the mobile auto entertainment unit 1 at a predetermined viewing angle B with respect to the docking frame 10 within the adjustable cavity 301.

The pivot joint 122 comprises a pivot shaft extended from the corresponding side arm 11 of the docking frame 10 to rotatably insert into the sliding slot 121 so that the mobile auto entertainment unit 1 is allowed to pivotally move with respect to the side arm 11.

The adjustable locker 123 comprises a locker shaft 1231 rotatably mounted at the corresponding side arm 11 of the docking frame 10 to rotatably insert into the sliding slot 121 and a biasing member 1232 attached to the locker shaft 1231 for substantially biasing against the respective sidewall of the mobile auto entertainment unit 1 so as to lock up the mobile auto entertainment unit 1 at the side arm 11 in a pivotally movable manner, as shown in FIG. 4B.

Accordingly, when an end portion of the locker shaft 1231 is rotatably slid out of the respective sliding slot 121, the mobile auto entertainment unit 1 is capable of detached from the docking frame 10. As shown in FIG. 4A, when the end portion of the locking shaft 1231 is rotatably inserted into the sliding slot 121, the mobile auto entertainment unit 1 is capable of selectively adjusting the viewing angle B thereof. Once the preferred viewing angle B of the mobile auto entertainment unit 1 is set, the locking shaft 1231 is further rotated towards to the sliding slot 121 until the biasing member 1232 is biased against the sidewall of the mobile auto entertainment unit 1, as shown in FIG. 4B, so as to securely lock up the mobile auto entertainment unit 1 at the viewing angle B.

It is worth to mention that the adjustable cavity 301 creates a space for maximizing the viewing angle B of the mobile auto entertainment unit 1. Without the retention unit 30, a tightly fastened docking frame 10 will cause the mobile auto entertainment unit 1 to overlappedly contact with rear side of a vehicle seat 2. So the retention unit 30 not only functions as a fastening assisting device, but also serves as an adjustable device for satisfying an ergonomic concern by making the docking frame 10 stable and ergonomic friendly.

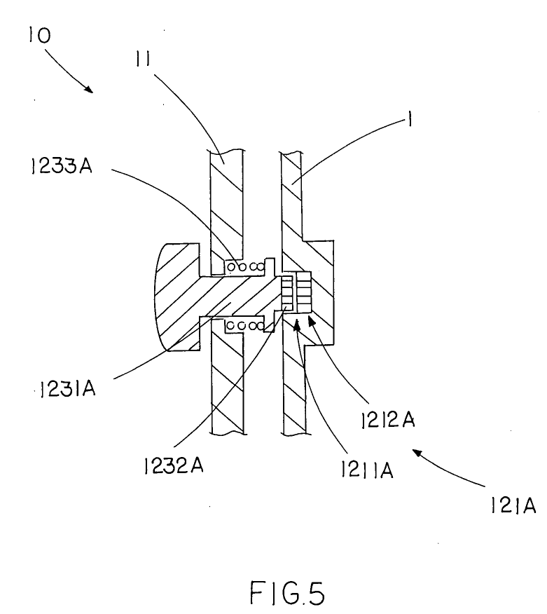

FIG. 5 illustrates an alternative of the adjustable locker 123A wherein the sliding slot 121A, having an outer rotating portion 1211A and an inner locking portion 1212A, is formed on the respective sidewall of the mobile auto entertainment unit 1. The adjustable locker 123A comprises a locker shaft 1231A, having a locker end 1232A, slidably mounted at the respective side arm 11 of the docking frame 10, wherein when the locker end 1232A of the locker shaft 1231A is slidably inserted into the rotating portion 1211A of the sliding slot 121A, the mobile auto entertainment unit 1 is allowed to freely moved in a pivotally movable manner to adjust the viewing angle thereof. When the locker end 1232A of the locker shaft 1231A is further slidably inserted into the locking portion 1212A of the sliding slot 121A, the mobile auto entertainment unit 1 is locked up at the viewing angle. Accordingly, the locker end 1232A of the locker shaft 1231A has a radially engaging teeth structure and the locking portion 1212A of the sliding slot 121A has the corresponding radially teeth structure such that when the locker shaft 1231A is inserted into the sliding slot 121A to substantially engage the locker end 1232A of the locker shaft 1231A with the locking portion 1212A of the sliding slot 121A, the mobile auto entertainment unit 1 is locked up between the two side arms 11 at the viewing angle.

The adjustable locker 123A further comprises a resilient element 1233A mounted to the locker shaft 1231A for providing an urging force against the locker shaft 1231A so as to normally push the locker end 1232A of the locker shaft 1231A towards the locking portion 1212A of the sliding slot 121A. Accordingly, the resilient element 1233A comprises a compression spring having two ends biasing against the locker shaft 1231A and the side arm 11 of the docking frame 10 respectively to urge the locker shaft 1231A to slidably insert into the sliding slot 121A so as to ensure the engagement between the locker end 1232A of the locker shaft 1231A and the locking portion 1212A of the sliding slot 121A.

In other words, the user is able to adjust the viewing angle B of the mobile auto entertainment unit 1 via the angle adjusting arrangement 12 and the titled angle A of the mobile auto entertainment unit 1 via the retention unit 30 such that the user is able to adjust the best eye-to-screen distance of the mobile auto entertainment unit 1 by the detachable mounting device of the present invention.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A detachable mounting device for detachably mounting a mobile auto entertainment unit to a vehicle seat, comprising:
a docking frame for detachably mounting said mobile auto entertainment unit;
a fastening unit having a fastening loop for detachably fastening to said vehicle seat to support said docking frame at a rear side of said vehicle seat; and
a retention unit pivotally connected with said docking frame, wherein when said retention unit is outwardly and pivotally folded from said docking frame for biasing against said rear side of said vehicle seat, said retention unit is adapted to not only minimize a clearance of said fastening loop with respect to said vehicle seat to retain said docking frame in position but also selectively adjust a tilted angle of said docking frame with respect to said rear side of said vehicle seat for adjusting an eye-to-screen distance of said mobile auto entertainment unit.

2. The detachable mounting device, as recited in claim 1, wherein said retention unit comprises an upper retention member pivotally connecting to an upper portion of said docking frame and a lower retention member pivotally connecting to a lower portion of said docking frame, wherein each of said upper and lower retention members, having a U-shaped structure, comprises two pivot arms pivotally extended from said docking frame and a retention arm extended between said two pivot arms in such a manner that when said pivot arms are pivotally folded from said docking frame, said retention arms are folded for substantially biasing against said rear side of said vehicle seat to push said docking frame spacedly apart therefrom so as to minimize said clearance of said fastening loop with respect to said vehicle seat.

3. The detachable mounting device, as recited in claim 1, wherein said docking frame comprises two side arms laterally disposed in a parallel manner for receiving said mobile auto entertainment unit therebetween and an angle adjusting arrangement provided at said two side arms for pivotally mounting said mobile auto entertainment unit in position between said two side arms.

4. The detachable mounting device, as recited in claim 2, wherein said docking frame comprises two side arms laterally disposed in a parallel manner for receiving said mobile auto entertainment unit therebetween and an angle adjusting arrangement provided at said two side arms for pivotally mounting said mobile auto entertainment unit in position between said two side arms.

5. The detachable mounting device, as recited in claim 3, wherein said angle adjusting arrangement has two sliding slots provided at two sides of said mobile auto entertainment unit and comprises a pivot joint formed on one of said side arms to rotatably engage with said corresponding sliding slot and an adjustable locker formed on another said side arm to engage with another said sliding slot for locking up said mobile auto entertainment unit at a predetermined viewing angle with respect to said docking frame within said adjustable cavity.

6. The detachable mounting device, as recited in claim 4, wherein said angle adjusting arrangement has two sliding slots provided at two sides of said mobile auto entertainment unit and comprises a pivot joint formed on one of said side arms to rotatably engage with said corresponding sliding slot and an adjustable locker formed on another said side arm to engage with another said sliding slot for locking up said mobile auto entertainment unit at a predetermined viewing angle with respect to said docking frame within said adjustable cavity.

7. The detachable mounting device, as recited in claim 1, wherein said the fastening unit comprises two length-adjustable elongated straps sidewardly extended from two sides of said docking frame and two fasteners provided at two free ends of said elongated straps respectively, wherein said two fasteners are detachably attached together to form said fastening loop by said elongated straps.

8. The detachable mounting device, as recited in claim 2, wherein said the fastening unit comprises two length-adjustable elongated straps sidewardly extended from two sides of said docking frame and two fasteners provided at two free ends of said elongated straps respectively, wherein said two fasteners are detachably attached together to form said fastening loop by said elongated straps.

9. The detachable mounting device, as recited in claim 4, wherein said the fastening unit comprises two length-adjustable elongated straps sidewardly extended from two sides of said docking frame and two fasteners provided at two free ends of said elongated straps respectively, wherein said two fasteners are detachably attached together to form said fastening loop by said elongated straps.

10. The detachable mounting device, as recited in claim 6, wherein said the fastening unit comprises two length-adjustable elongated straps sidewardly extended from two sides of said docking frame and two fasteners provided at two free ends of said elongated straps respectively, wherein said two fasteners are detachably attached together to form said fastening loop by said elongated straps.
